(19) United States
(12) Patent Application Publication
(10) Pub. No.: US 2022/0072608 A1
(43) Pub. Date: Mar. 10, 2022

(54) SINTERING APPARATUS FOR SELECTIVE ENERGIZATION

(71) Applicant: SEOUL NATIONAL UNIVERSITY R&DB FOUNDATION, Seoul (KR)

(72) Inventors: Jong-Hun RYU, Seoul (KR); Chan PARK, Seoul (KR); Mi-Young KIM, Seoul (KR); Heung-Nam HAN, Seoul (KR); Jun-Young CHO, Seoul (KR); Woo-Chan JIN, Seoul (KR)

(73) Assignee: SEOUL NATIONAL UNIVERSITY R&DB FOUNDATION, Seoul (KR)

(21) Appl. No.: 17/416,159

(22) PCT Filed: Nov. 5, 2019
(86) PCT No.: PCT/KR2019/014919

§ 371 Date: Jun. 18, 2021

(30) Foreign Application Priority Data
Dec. 21, 2018 (KR) 10-2018-0167288

(51) Int. Cl. B22F 3/00; B22F 3/14

(52) U.S. Cl. CPC B22F 3/003; B22F 3/14

(57) ABSTRACT

One embodiment of the present invention provides a sintering apparatus for selectively applying electric current, comprising: a mold provided with a space for accommodating a target object; a punch for uniaxially pressing the space of the mold; an electric controller provided at an end of the punch opposite to the pressing direction; an electrode unit in contact with the electric controller; and a heater extending from the electrode unit so as to heat the mold, wherein the mold and the punch are formed with a conductor.

### TECHNICAL FIELD

The present disclosure relates to a sintering apparatus, and more specifically relates to the sintering apparatus for performing selective energization or non-energization sintering depending on a material to be sintered.

### BACKGROUND ART

The energization pressurizing sintering is a sintering method performed by inserting powder of a material to be sintered into a mold made of a conductive material, and then pressing the mold and energizing currents at the same time to generate Joule's heat through controlling an amount of energized currents of the mold and a green compact, thereby heating up to a sintering temperature to be targeted.

However, in a method of the energization pressurizing sintering as described above, a deviation in density is large depending on a resistivity value of the material to be sintered. In particular, in the case of ceramic materials, the energized current is concentrated in the mold, so that an external temperature of a sintered body may be higher than an internal temperature thereof.

Also, when conducting energization and sintering by applying an insulating material to the material to be sintered, a partial leakage current may not be completely blocked and there may be a risk that a chemical reaction with an insulating layer occurs, thereby increasing groups of unusable materials.

As a document of the related art, there is PLASMA SINTERING APPARATUS AND METHOD disclosed in Korean unexamined patent application publication No. 10-2016-0093968. Specifically, the document of the related art provides the plasma sintering apparatus including a silicon carbide (SiC) mold for filling power to be processed; upper and lower punches for pressurizing the powder to be processed; upper and lower electrodes for operating the upper and lower punches; a temperature measuring portion for measuring a temperature of the silicon carbide (SiC) mold; a control portion for controlling a heating voltage based on a temperature of the silicon carbide (SiC) mold measured by the temperature measuring portion; and a direct current (DC) power supply for varying the DC power to be supplied to the upper electrode and the lower electrode under control of the control portion.

### DISCLOSURE

### Technical Problem

The present disclosure is for solving the above-mentioned problems of the related art. The present disclosure is for providing a sintering apparatus for selective energization which enables energization or non-energization sintering selectively depending on the material to be sintered, has a heater of a unique structure to minimize a temperature deviation upon sintering, and does not incur the other variables other than energization.

### Technical Solution

In order to achieve the above, one aspect of the present disclosure provides a sintering apparatus for selective energization, including: a mold provided with a space for accommodating a target object; punches for uniaxially pressing the space of the mold; electric controllers provided at an end of each punch opposite to a pressing direction; an electrode portion in contact with the electric controllers; and a heater extended from the electrode portion to heat the mold, wherein the mold and the punches are formed of a conductor.

### Advantageous Effects

According to one aspect of the present disclosure, if a material to be sintered is a conductive material, pressurizing and sintering may be performed by energization and heating through an outer heater.

Also, if the material to be sintered is a nonconductive material, pressurizing and sintering may be performed by heating through the outer heater under the same condition for sintering the conductive material while the mold is not energized.

It should be understood that an effect of the present disclosure is not limited by the above effect, and includes all effects which may be deduced from a configuration of the invention described in the detailed description of the invention or the scope of claims.

### DESCRIPTION OF DRAWINGS

FIG. 1 is a schematic view of presenting one example of a sintering apparatus for selective energization according to one embodiment of the present disclosure.

FIGS. 2 and 3 are perspective views of presenting one example of a heater and a conductive member of a sintering apparatus for selective energization according to one embodiment of the present disclosure.

FIG. 4 is a perspective view of presenting one example in which a heater and a conductive member of a sintering apparatus for selective energization according to one embodiment of the present disclosure are coupled.

FIG. 5 is a perspective view of presenting one example of a mold, a heater, a conductive member, and a cover before pressurizing a sintering apparatus for selective energization.

### BEST MODE FOR CARRYING OUT THE INVENTION

A sintering apparatus for selective energization according to the present disclosure includes: a mold provided with a space for accommodating a target object; punches for uniaxially pressing the space of the mold; an electric controller provided at an end of each punch opposite to a pressing direction; an electrode portion in contact with the electric controller; and a heater extended from the electrode portion to heat the mold, wherein the mold and the punches are formed of a conductor.

### BEST MODE

Hereinafter, referring to the attached drawings, preferable embodiments according to the present disclosure will be specifically described.

Advantages and features of the present disclosure, and a method of achieving the same will be clarified by referring to embodiments which is specifically described hereinafter together with enclosed drawings.

However, the present disclosure is not limited by embodiments to be disclosed hereinafter but may be also realized in various different forms. This embodiment is merely provided to complete the content of the present disclosure and to fully inform those skilled in the art of a category of the present disclosure. Also, the present disclosure is only defined by a category of claims.

Furthermore, in describing the present disclosure, the detailed description of related known technologies, etc. may be omitted if it is deemed to make the gist of the present disclosure vague.

According to one aspect of the present disclosure, provided is a sintering apparatus for selective energization 100, including:

a mold 105 provided with a space for accommodating a target object;

punches 104a, 104b for uniaxially pressing the space of the mold;

electric controllers 103a, 103b provided at an end of each punch opposite to a pressing direction;

an electrode portion in contact with the electric controllers; and

a heater 102 extended from the electrode portion to heat the mold, wherein

the mold and the punches are formed of a conductor.

Hereinafter, the sintering apparatus for selective energization 100 and each configuration according to one aspect of the present disclosure is specifically described.

The punches 104a, 104b may include a first punch 104a which presses one direction of the space of the mold 105 and a second punch 104b which presses the other direction of the space of the mold. After inserting the target object into the space of the mold, uniaxial pressing may be performed by the punches. Also, when energization sintering of the target object is performed, the punches may be formed of a conductor in order that currents may flow through the punches.

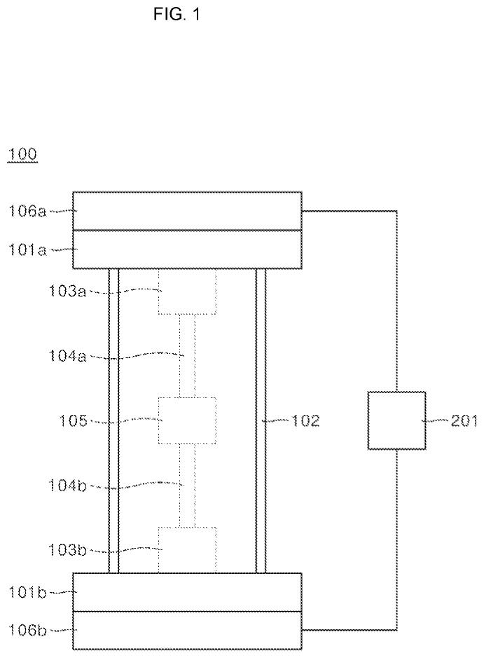

As shown in FIG. 1, the punches 104a, 104b may pressurize the target object inserted into the space of the mold upwardly and downwardly.

By means of the mold 105, a space for accommodating the target object to be sintered is prepared, and pressing of the space is performed by the punches. The mold may be formed of a conductor in the same way of the punches.

The electric controllers 103a, 103b may be prepared at an end of the punches 104a, 104b opposite to a pressing direction. Specifically, if the punches are configured as the first punch 104a and the second punch 104b, a first electric controller 103a may be prepared at an end of the first punch opposite to a pressing direction, and a second electric controller 103b may be prepared at an end of the second punch opposite to a pressing direction.

The electric controllers 103a, 103b may control to block or allow flow of currents from the electrode portion to the mold so as to perform energization or non-energization sintering of the target object. If the target object is a conductive material, the electric controllers may be formed of a conductor in order that the mold 105 and the electrode portion may be energized. If the target object is a nonconductive material, the electric controllers may be formed of a nonconductor in order that the mold and the electrode portion are not energized.

The electric controllers 103a, 103b may be prepared to be detached or attached from the punches and the electrode portion.

The electric controllers 103a, 103b may be provided with a switch for blocking currents and enable selective energization by changing a material in contact with the electrode portion or the punches to a conductor or a nonconductor according to an operation of the switch.

Part of the electric controllers 103a, 103b may be in a state of being detached from the electrode portion before pressing the mold 105, and may be in contact with the electrode portion while pressing of the mold is performed.

The electrode portion may include a conductive member in contact with the electric controller; and an electrode connected to the conductive member. Specifically, the electrode portion may include a first conductive member 101a and a second conductive member 101b which are in contact with the first electric controller 103a and the second electric controller 103b respectively. Also, the electrode portion may include a first electrode 106a and a second electrode 106b which are electrically connected with the first conductive member and the second conductive member respectively.

The sintering apparatus for selective energization 100 may further include a power supply 201 for applying a pulse current to the electrode portion and for driving the heater. Also, the electrode portion may include a pressurizing portion (not shown) for generating uniaxial pressurized driving force of the punches 104a, 104b. The sintering apparatus for selective energization may include a controller (not shown) which is connected to the power supply and a pressurizing portion and controls a pressure of the pressurizing portion.

The power supply 201 controls a current amount of the heater 102, the mold 105, and the target object of the mold to adjust a sintering temperature.

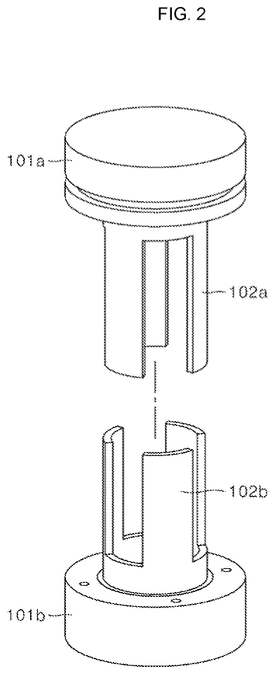

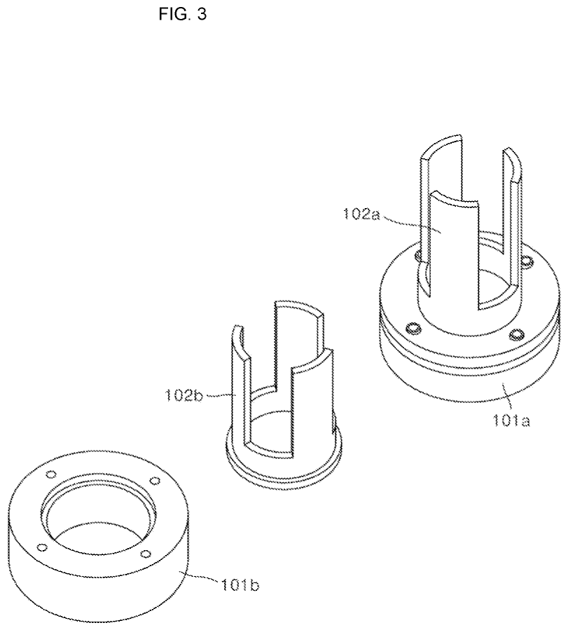

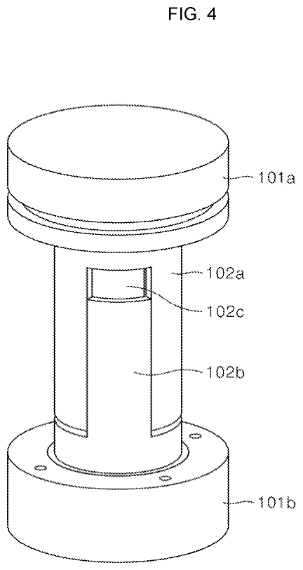

Referring to FIG. 2, the heater 102 may include a first heater 102a extended from the first conductive member 101a to a pressing direction of the first punch 104a; and a second heater 102b extended from the second conductive member 101b to a pressing direction of the second punch 104b. Here, when pressurizing of the sintering apparatus for selective energization 100 is performed, one side of the first heater may be coupled to one side of the second heater. Specifically, a concave portion or a convex portion having a square shape may be formed in order that the first heater and the second heater are engaged upon coupling. Here, when the first heater and the second heater are coupled, a predetermined gap 102c is formed as shown in FIG. 4. Accordingly, even upon sintering at a high temperature and a high pressure, a crack of the heater does not occur. Furthermore, a graphene film, etc. may be attached to a part, where the first and second heaters are in contact with upon coupling so as to minimize a heat loss.

In order that the first and second heaters 102a, 102b may rotate upon sintering after coupling, a groove corresponding to a cross section of the heaters may be formed at the first and second conductive members 101a, 101b. The heaters may be prepared in a cylindrical shape.

A material of the heater 102 nearly does not have deformation due to heat in a conventional range of a sintering temperature. A material of which thermal conductivity, electrical conductivity, and thermal emissivity are excellent may be used. Specifically, graphite, etc. may be used.

A heating rate of the heater 102 may be 400 to 600° C./min.

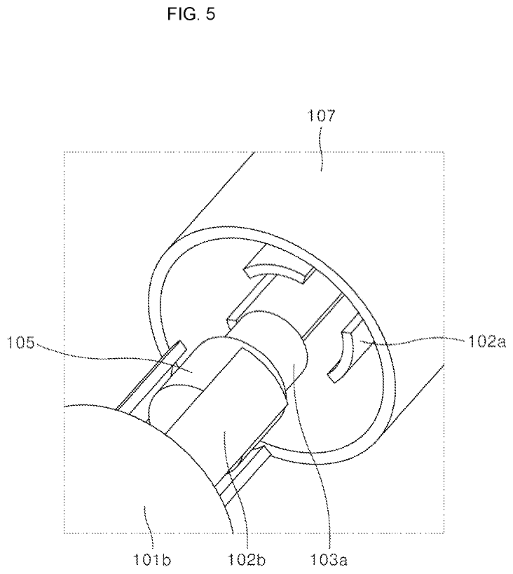

Referring to FIG. 5, the sintering apparatus for selective energization 100 may further include a cover 107 for surrounding an outer circumferential surface of the heater 102. Based on the above, a loss of heat of the heater and heat to be incurred by selective energization may be minimized.

That is, the sintering apparatus for selective energization 100 according to one example of the present disclosure performs energization or non-energization sintering depending on a target object. Except a variable related to energization, there may be no changes in the other variables (pressurization, atmosphere of air, a temperature of a heater, etc.).

Until now, specific embodiments related to the sintering apparatus for selective energization according to one example of the present disclosure are described. However, various modifications may be made within a limit, which does not deviate from a range of the present disclosure.

Therefore, the range of the present disclosure should not be limited by the described embodiments but should be defined by not only the scope of claims to be described thereinafter but also equivalents thereof.

That is, the above embodiments should be understood to be exemplary in all of aspects and not to be limited. The range of the present disclosure is presented by the scope of claims to be described hereinafter other than the detailed description. It should be understood that all changes or changed forms derived from the meaning and the range of the scope of claims, and equivalent concepts thereof are included in the scope of the present invention.

### INDUSTRIAL APPLICABILITY

If a material to be sintered is a conductive material, pressurizing and sintering may be performed by energization, and heating through an outer heater. If the material to be sintered is a nonconductive material, pressurizing and sintering may be performed by heating through the outer heater under the same condition for sintering the conductive material while the mold is not energized.

### Sequence Listing Free Text

(None)

1. A sintering apparatus for selective energization, comprising:
a mold provided with a space for accommodating a target object;
first and second punches for uniaxially pressing the space of the mold;
an electric controller provided at an end of each punch opposite to a pressing direction;
an electrode portion in contact with the electric controller; and
a heater extended from the electrode portion to heat the mold, wherein
the mold and the punches are formed of a conductor, and
the electric controller controls to block or allow a current flow from the electrode portion to the mold according to conductivity of the target object.

2. The sintering apparatus for selective energization of claim 1, wherein
the electrode portion comprises:
conductive members in contact with the electric controller; and
electrodes connected to the conductive members, and wherein
the heater is extended from the conductive member to heat the mold.

3. The sintering apparatus for selective energization of claim 1, wherein
the electric controller is configured not to:
apply an electric current to the mold and the electrode portion when the target object is a nonconductive material.

4. The sintering apparatus for selective energization of claim 1, wherein
the electric controller is configured to:
apply an electric current to the mold and the electrode portion when the target object is a conductive material.

5. The sintering apparatus for selective energization of claim 1, wherein
the punches include:
a first punch and a second punch which press one direction and the other direction of the space of the mold respectively,
the electric controller includes:
a first electric controller and a second electric controller provided at ends of the first and second punches opposite to pressing directions respectively, and
the electrode portion includes:
a first conductive member and a second conductive member which are in contact with the first electric controller and the second electric controller respectively, and includes a first electrode and a second electrode which are connected with the first conductive member and the second conductive member respectively.

6. The sintering apparatus for selective energization of claim 5, wherein
the heater includes:
a first heater extended from the first conductive member to the pressing direction of the first punch; and a second heater extended from the second conductive member to the pressing direction of the second punch, and
when pressurization is performed by the first and second punches, one side of the first heater and one side of the second heater are coupled.

7. The sintering apparatus for selective energization of claim 6, wherein
when the first heater and the second heater are coupled, a predetermined gap is formed.

8. The sintering apparatus for selective energization of claim 6, wherein
in the first and second heaters,
a concave portion or a convex portion having a square shape is formed to be engaged upon coupling.

9. The sintering apparatus for selective energization of claim 1, further comprising:
a power supply for applying a pulse current to the electrode portion and for driving the heater.
